(19) United States
(12) Patent Application Publication
(10) Pub. No.: US 2018/0347482 A1
(43) Pub. Date: Dec. 6, 2018

(54) METHOD AND SYSTEM FOR CONTROLLING A TURBOCHARGER ACTUATOR IN A VEHICLE PROPULSION SYSTEM

(71) Applicant: GM GLOBAL TECHNOLOGY OPERATIONS LLC, DETROIT, MI (US)

(72) Inventor: Joseph W. Folk, Troy, MI (US)

(21) Appl. No.: 15/607,768

(22) Filed: May 30, 2017

(51) Int. Cl. F02D 41/00; F02B 37/24

(52) U.S. Cl. CPC F02D 41/0007; F16K 31/02; F02B 37/24

(57) ABSTRACT

A method for controlling an electric actuator of a turbocharger in a vehicle propulsion system includes determining whether an internal combustion engine in the vehicle propulsion system is operating, determining whether an actuation condition is satisfied, and operating the electric actuator a first time in response to a determination that the internal combustion engine in the vehicle propulsion system is not operating and that the actuation condition is satisfied.

### FIELD

The present disclosure relates to method and system for controlling a turbocharger actuator in a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Many vehicle propulsion systems include a turbocharger that may be controlled or actuated when the engine is operating. In particular, many turbochargers incorporate an actuator that may rely upon a pressure differential to operate. For example, a turbocharger may include a waste gate or variable geometry vanes that are pneumatically operated. In order to generate the pressure differential that is required for pneumatic operation, the vehicle engine must be operating. At least a portion of these actuators may include an element that is mounted externally and, thus, may be exposed to corrosive elements that may be present in the environment in which the vehicle operates. In many instances, this is not a problem as the engine is operated any time the vehicle is operated which will result in actuation of the turbocharger frequently enough such that any exposed element may have corrosive elements wiped and/or otherwise removed during the operation of the turbocharger actuator. However, if the engine is not operated for an extended period of time the turbocharger may not be operated and, in turn, the actuators may not be operated. As a result, corrosive elements may accumulate on the actuators which may increase the corrosion of these turbocharger actuator elements and they may fail due to the corrosion.

FIG. 1 illustrates an internal combustion engine 100 for a vehicle propulsion system which includes a turbocharger 102. The turbocharger 102 includes a turbine 104 driving a compressor 106 via a shaft 108. Via an intake channel 110 ambient air is compressed by the compressor 106 and led to an engine 112. Via an exhaust channel 114 exhaust gases from the engine 112 can be led through the turbine 104. A part of the exhaust gas can bypass the turbine 104 via a bypass 116. The bypass 116 can be opened and closed by a waste gate 118, which is operated by a waste gate actuator 120. The waste gate actuator 120 is spring biased in a closing direction of the waste gate 118 with a spring 122. For opening the waste gate 118 the biasing force of the spring 122 has to be overcome. To the waste gate actuator 120 a pressure is applied via a boost line 124. The boost line 124 is pressurized from the intake channel 110 via a boost valve 126. The boost valve 126 is a control element for operating the waste gate 118. For controlling the turbocharger 102 the boost valve 126 is controlled by a controller 128. The controller 128 receives data via a data line 130 about the ambient air pressure and the ambient air temperature of the ambient air. By means of the received data the controller 128 corrects by means of a mathematical formula a stored set of values of a basic boost pressure, which is required for opening the waste gate 118, under specific conditions.

FIG. 1 further illustrates a linkage 132 that connects the waste gate actuator 120 to the waste gate 118. The linkage 132 may be positioned externally to a housing (not shown) of the turbocharger 102 and, thus, may be exposed to a corrosive environment. Referring now to FIG. 2, a similarly exposed actuator linkage may be more clearly illustrated. The turbocharger 200 includes a pneumatically operated actuator 202 that operates a portion of the turbocharger 200 via a linkage 204. In this instance, the turbocharger 200 may be a type which has variable geometry vanes and the actuator 202, via the linkage 204, may operate to alter the geometry of the vanes within the turbocharger 200. As is clearly evident, the linkage 204 is exposed to the environment and, thus, may be subject to exposure to corrosive elements in that environment. In contrast, the other moving elements (not shown) of the turbocharger 200 are protected from the environment by the turbocharger housing 206.

### SUMMARY

In an exemplary aspect, a method for controlling an electric actuator of a turbocharger in a vehicle propulsion system includes determining whether an internal combustion engine in the vehicle propulsion system is operating, determining whether an actuation condition is satisfied, and operating the electric actuator a first time in response to a determination that the internal combustion engine in the vehicle propulsion system is not operating and that the actuation condition is satisfied.

In another exemplary aspect, the method further includes determining the amount of time that has elapsed since the internal combustion engine has operated and the actuation condition includes the amount of time that has elapsed since the internal combustion engine has operated exceeds a predetermined threshold.

In another exemplary aspect, the method further includes determining a geographic area of a vehicle that includes the vehicle propulsion system and wherein the actuation condition includes the vehicle being located in a predetermined geographic area.

In another exemplary aspect, the method further includes determining the time of year and wherein the actuation condition includes the time of year corresponding to a predetermined time of year.

In another exemplary aspect, the method further includes determining the ambient air temperature and wherein the actuation condition includes the ambient air temperature being below a predetermined threshold.

In another exemplary aspect, the method further includes determining the amount of time that has elapsed since the electric actuator was operated the first time, and operating the electric actuator a second time in response to a determination that the amount of time that has elapsed since the amount of time that has elapsed since the electric actuator was operated the first time exceeds a predetermined threshold.

In another exemplary aspect, operating the electric actuator the first time includes operating the electric actuator a predetermined number of times.

In another exemplary aspect, the electric actuator includes a waste gate actuator for the turbocharger.

In another exemplary aspect, the turbocharger includes a variable vane geometry and wherein electric actuator includes a vane geometry controller for the variable vane geometry turbocharger.

In this manner, the potential for a turbocharger actuator in a vehicle propulsion system to experience corrosion and the degree to which that actuator may be corroded is significantly reduced and/or eliminated. Further, this reduces or eliminates the need for potentially expensive corrosion resistant materials being used for the actuator and for any splash shielding.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of an exemplary vehicle propulsion system;

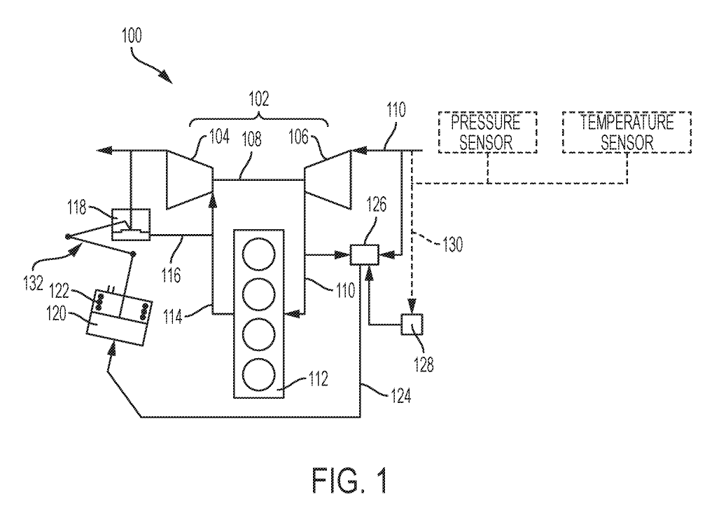

FIG. 2 is a perspective view of an exemplary turbocharger having an exposed actuator linkage; and

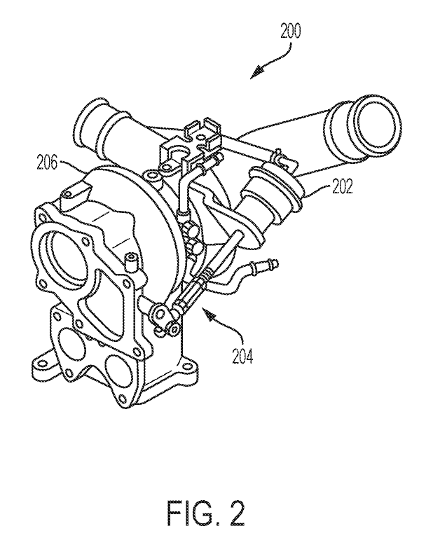

FIG. 3 is a flowchart for an exemplary method in accordance with the present invention.

### DETAILED DESCRIPTION

As vehicle propulsions systems continue to develop, a trend toward hybrid vehicle propulsion systems has arisen. Hybrid vehicle propulsion systems typically include a combination of an internal combustion engine and one or more electric motors. Hybrid vehicle propulsion systems vary in the manner in which power is provided to propel the vehicle, some hybrid systems may rely primarily upon the internal combustion engine and only supplement the engine using an electric motor, others may primarily rely upon the electric motor to propel the vehicle and rely upon the internal combustion engine to provide supplemental power, either to propel the vehicle and/or to recharge the battery that powers the electric motor. The degree to which the electric motor is relied upon for power in comparison to the internal combustion engine may vary. Those hybrids which rely upon the internal combustion engine primarily may be referred to as a “weak” or “mild” hybrid while those relying primarily upon the electric motor may be referred to as a “strong” hybrid. Some hybrid vehicle propulsion systems may also include the ability to “plug-in” or connect to an external electric power supply to replenish a battery which stores energy for use by the electric motor. Further, some of these hybrid propulsion systems may also include an electrically actuated turbocharger that operates together to improve the performance of the internal combustion engine.

As explained above, vehicle propulsion systems may operate within a wide variety of environments, some of which may result in exposure of the vehicle components to corrosive elements. For example, a vehicle that is operated in a northern environment may be exposed to salts that may have been distributed on the roads or a vehicle that is operated in a coastal environment may be exposed to corrosive sea air.

Prior to the introduction of hybrid vehicle propulsion systems, internal combustion engines were operated continuously and, as a result, the turbocharger actuators were frequently cycled. The cycling of the actuator tends to remove and/or prevent the buildup of debris including potentially corrosive elements. The actuation of the various actuators have been known to reduce and/or mitigate the consequences of being exposed to a corrosive environment. The potentially harmful elements may be brushed away and/or cleaned off when the actuators are operated. However, many hybrid vehicle propulsion systems may operate for an extended period of time without operating the internal combustion engine. Therefore, those components of a hybrid vehicle propulsion system which are only actuated when the internal combustion engine is operated may experience extended exposure to potentially corrosive elements.

Recent developments in vehicle propulsion systems have led to turbochargers that may incorporate an electric actuator. Electric actuation of turbochargers may offer a faster response than a pneumatic actuator, improved fuel efficiency, and improved emissions performance. Additionally, overall control of the turbocharger may be more precisely controlled. This may result in improved performance, greater fuel efficiency and emissions control. The inventor realized that the increased availability of electrically actuated elements provide the opportunity to periodically operate the actuators to reduce and/or remove the potentially corrosive elements even in the absence of operating the internal combustion engine.

Areas of concern for corrosion on the actuator include an actuator rod and a pin joint. Corrosion of these elements may increase the resistance to operation of the actuator and may even prevent operation. The inventor discovered that periodic operation of the turbocharger actuator when the associated internal combustion engine is not operating tends to significantly reduce the corrosion of the actuator elements. Actuation tends to remove corrosive elements. The frequency and number of times which the actuator may be operated may be determined through known calibration techniques. Further, the actuation may further be optimized for any known factor which may have an effect upon corrosive potential such as, for example, the number of miles traveled without operating the engine, the amount of time which has elapsed without operating the engine, the season or time of year such as an increased frequency in winter where temperatures more frequently drop below freezing which may increase the risk of the vehicle being exposed to corrosive elements in anti-icing products applied to the road surface, the geographic location of the vehicle such as being located in a coastal environment, and the like without limitation.

As a result of the reduced tendency for corrosion by periodic operation of the turbocharger actuator when the engine is not operating, reliance upon other more expensive options for reducing corrosion such as, for example, the use of expensive corrosion resistant materials or splash shielding.

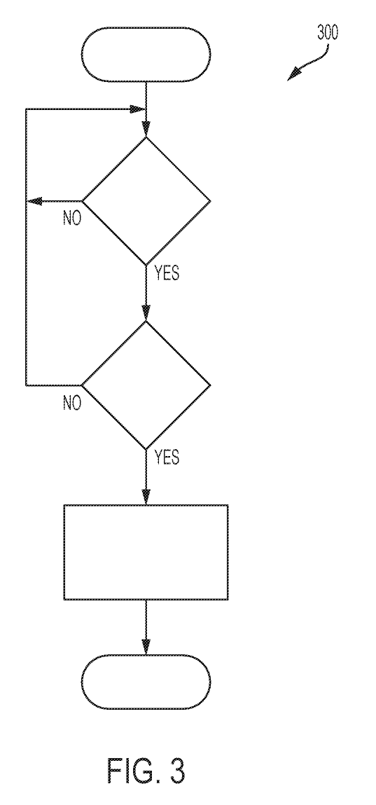

FIG. 3 is a flowchart of an exemplary method 300 in accordance with the present invention. The method 300 starts at step 302 and continues to step 304. In step 304 the controller determines whether the internal combustion engine in the vehicle propulsion system is operating. If, in step 304, the controller determines that the engine in the vehicle propulsion system is operating the method returns to step 302. If, however, in step 304 the controller determines that the engine in the vehicle propulsion system is not operating then the method continues to step 306. In step 306, the controller determines whether an actuation condition is satisfied. The actuation condition may include any condition which may have an effect upon the corrosive risk for the actuator elements, such as, for example, whether a predetermined period of time has elapsed since the engine has been operated. If, in step 306, the controller determines that the actuation condition is not satisfied, then the method returns to step 302. If, however, in step 306, the controller determines that the actuation condition is satisfied, then the method continues to step 308. In step 308, the controller actuates the turbocharger actuator element a predetermined number of times. The method then continues to step 310 where the method ends.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for controlling an electric actuator of a turbocharger in a vehicle propulsion system, the method comprising:
determining whether an internal combustion engine in the vehicle propulsion system is operating;
determining whether an actuation condition is satisfied; and
operating the electric actuator a first time in response to a determination that the internal combustion engine in the vehicle propulsion system is not operating and that the actuation condition is satisfied.

2. The method of claim 1, further comprising determining the amount of time that has elapsed since the internal combustion engine has operated and wherein the actuation condition comprises the amount of time that has elapsed since the internal combustion engine has operated exceeds a predetermined threshold.

3. The method of claim 1, further comprising determining a geographic area of a vehicle that includes the vehicle propulsion system and wherein the actuation condition comprises the vehicle being located in a predetermined geographic area.

4. The method of claim 1, further comprising determining the time of year and wherein the actuation condition comprises the time of year corresponding to a predetermined time of year.

5. The method of claim 1, further comprising determining the ambient air temperature and wherein the actuation condition comprises the ambient air temperature being below a predetermined threshold.

6. The method of claim 1, further comprising:
determining the amount of time that has elapsed since the electric actuator was operated the first time; and
operating the electric actuator a second time in response to a determination that the amount of time that has elapsed since the amount of time that has elapsed since the electric actuator was operated the first time exceeds a predetermined threshold.

7. The method of claim 1, wherein operating the electric actuator the first time comprises operating the electric actuator a predetermined number of times.

8. The method of claim 1, wherein the electric actuator comprises a waste gate actuator for the turbocharger.

9. The method of claim 1, wherein the turbocharger comprises a variable vane geometry and wherein electric actuator comprises a vane geometry controller for the variable vane geometry turbocharger.

10. A vehicle propulsion system, the system comprising:
an internal combustion engine having an intake and an exhaust;
a turbocharger with a compressor in communication with the intake, a turbine in communication with the exhaust, and an electric actuator that controls operation of the turbocharger;
a controller in communication with the electric actuator, wherein the controller determines whether the internal combustion engine is operating and whether an actuation condition is satisfied, and wherein the controller operates the electric actuator a first time when the controller determines that the internal combustion engine is not operating and that the actuation condition is satisfied.

11. The vehicle propulsion system of claim 10, wherein the controller further determines the amount of time that has elapsed since the internal combustion engine has operated and wherein the actuation condition comprises the amount of time that has elapsed since the internal combustion engine has operated exceeds a predetermined threshold.

12. The vehicle propulsion system of claim 10, wherein the controller further determines a geographic area of a vehicle that includes the vehicle propulsion system and wherein the actuation condition comprises the vehicle being located in a predetermined geographic area.

13. The vehicle propulsion system of claim 10, wherein the controller further determines the time of year and wherein the actuation condition comprises the time of year corresponding to a predetermined time of year.

14. The vehicle propulsion system of claim 10, wherein the controller further determines the ambient air temperature and wherein the actuation condition comprises the ambient air temperature being below a predetermined threshold.

15. The vehicle propulsion system of claim 10, wherein the controller further determines the amount of time that has elapsed since the electric actuator was operated the first time and wherein the controller further operates the electric actuator a second time in response to a determination that the amount of time that has elapsed since the amount of time that has elapsed since the electric actuator was operated the first time exceeds a predetermined threshold.

16. The vehicle propulsion system of claim 10, wherein the controller operates the electric actuator a predetermined number of times.

17. The vehicle propulsion system of claim 10, wherein the electric actuator comprises a waste gate actuator for the turbocharger.

18. The vehicle propulsion system of claim 10, wherein the turbocharger comprises a variable vane geometry and wherein electric actuator comprises a vane geometry controller for the variable vane geometry turbocharger.
